(19) United States
(12) Patent Application Publication
(10) Pub. No.: US 2017/0061164 A1
(43) Pub. Date: Mar. 2, 2017

(54) TWO-DEVICE SCRAMBLED DISPLAY

(71) Applicant: McAfee, Inc., Santa Clara, CA (US)

(72) Inventors: Craig D. Schmugar, Hillsboro, OR (US); Clint R. Merrill, Hillsboro, OR (US); Erdem Aktas, Beaverton, OR (US); James Bean, Portland, OR (US); Cedric Cochin, Portland, OR (US); John D. Teddy, Portland, OR (US)

(73) Assignee: McAfee, Inc., Santa Clara, CA (US)

(21) Appl. No.: 14/752,878

(22) Filed: Jun. 27, 2015

(51) Int. Cl. G06F 21/84; H04L 29/06; H04L 9/12; H04L 9/08

(52) U.S. Cl. CPC G06F 21/84; H04L 9/083; H04L 63/068; H04L 9/12

(57) ABSTRACT

In an example, there is disclosed a system and method for a two-device scrambled display. A first device displays content in a scrambled form. A second device acts as an interpreter, including an input driver for receiving a scrambled input; an output driver for displaying an organically perceptible output; and one or more logic elements comprising a unscrambling engine operable for: receiving an input on the input driver; detecting that at least a portion of the input is scrambled; unscrambling the scrambled portion of the input; and outputting an unscrambled analog of the scrambled input via the output driver.

### FIELD OF THE SPECIFICATION

This disclosure relates in general to the field of device security, and more particularly, though not exclusively to, a system and method for providing a two-device encrypted display.

### BACKGROUND

An individual working in an environment where he requires privacy may be concerned about others looking “over his shoulder” at personal or controlled enterprise data. Existing solutions include, for example, privacy screens that block peripheral view physically, or that make the image unviewable from an angle.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a security-enabled network according to one or more examples of the present specification.

FIG. 2 is a block diagram of a computing device according to one or more examples of the present specification.

FIG. 3 is a block diagram of a server according to one or more examples of the present specification.

FIGS. 4A and 4B are a block diagram of an interpreter interoperating with an encrypted display according to one or more examples of the present specification.

FIG. 5 is a block diagram of interconnectivity according to one or more examples of the present specification.

FIG. 6 is a flow chart of a method according to one or more examples of the present specification.

FIG. 7 is a flow chart of a second method according to one or more examples of the present specification.

FIG. 8 is a flow chart of a third method according to one or more examples of the present specification.

### SUMMARY

In an example, there is disclosed a system and method for a two-device scrambled display. A first device displays content in a scrambled form. A second device acts as an interpreter, including an input driver for receiving a scrambled input; an output driver for displaying a human perceptible output; and one or more logic elements comprising a unscrambling engine operable for: receiving an input on the input driver; detecting that at least a portion of the input is scrambled; unscrambling the scrambled portion of the input; and outputting an unscrambled analog of the scrambled input via the output driver.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Different embodiments many have different advantages, and no particular advantage is necessarily required of any embodiment.

With increasing prevalence of mobile computing, it is not enough for an enterprise merely to secure its network. With users on the go, and accessing enterprise data from numerous devices in numerous locations, additional enterprise security apertures may open. For example, a user may be working off-site in a library or a coffee house. That user may log into an enterprise network, for example through a virtual network console (VNC) and work on important proprietary documents. While this behavior is desirable from certain perspectives—for example, it enables users to work on the road, and allows them flexibility in designing their schedules—it presents difficulties that are not as prevalent in a network environment where users work at a desktop or workstation within the enterprise.

To provide just one example, a user working at a coffee house may do his best to “zone out” distractions from other patrons. This means that the user may be deliberately ignoring others. The user may even use noise canceling headphones or earplugs to block out excessive noise. While this allows the user to better concentrate on his work, it also presents a difficulty. Because the user is intentionally blocking out his surroundings, he may not notice another person “shoulder surfing,” which may result in the exposure of important enterprise data. This could be an accidental occurrence, or in more extreme cases a malicious actor engaging in intentional industrial espionage. Thus, the enterprise is faced with a choice of either eliminating flexibility by restricting off-site access, or suffering the danger of shoulder surfing.

Other issues can also arise when the enterprise does not control the physical premises around its users. For example, in deliberate acts of espionage, an intruder may use specialized snooping devices to capture data streams or other useful information. While hardware and software encryption provide useful barriers against snooping, the “analog hole” still presents challenges. Specifically, for a user to be able to usefully interact with data, the data must be displayed in a form that the user can understand and manipulate. Unfortunately, if the intended user can understand and manipulate the data, then a malicious actor may also be able to understand and manipulate the data. Malicious users may use screen scrapers or other similar programs to capture data streams even when there is end-to-end encryption. If nothing else, a malicious user may operate sophisticated optical or acoustical detection equipment to simply watch the user's screen, or listen to an audio stream from the user's computer.

Recognizing the security implications of the “analog hole,” the applicants of the present application describe a system and method for effectively plugging the analog hole. In one embodiment, a user operates a client device such as a laptop computer provided with specialized software that scrambles some or all of an output stream, such as an audio and/or video stream. Thus, to an outside user, the display appears to be unintelligible garbage. Alternatively, the “real” output can be embedded within a false “decoy” output that appears to an outside user to be real output, but that actually masks the true output.

The genuine user is provided with a second device that includes an input sensor, a decryption key, an unscrambling engine, and an output driver for driving a human-perceptible output. This device is referred to throughout this specification as an interpreter. It should be understood that as used in this specification, an “interpreter” includes any combination of hardware and/or software configured to receive scrambled inputs and to provide to the user and an output that is an unscrambled analog of the input. In one example, an interpreter may take the form of smart glasses, smart speaker, smart ear buds, or a smart tactile driver.

Using smart glasses as an example, a user may operate a laptop computer with a display configured to scramble all or part of the display. In the case of a full display scramble, a user looking at the monitor without the benefit of smart glasses will see only an unintelligible jumble of pixels comparable to white noise, or a decoy image that appears to be legitimate output but that is, in fact, a false image with the true image stegonagraphically encoded within. The smart glasses may, however, contain a decryption key, and the necessary logic to detect the scrambled display, apply the decryption key to the scrambled image, unscramble the image, and display the actual data to the user wearing the glasses. The legitimate image may be superimposed on the user's view, such that it appears to map to the display itself. Alternately, the unscrambled display can be displayed in an alternate location, such as to the side or in a corner, so that the user can see both the scrambled display and the unscrambled display.

It will also be evident that a similar technique could be adapted to audio output. For example, the analog output of a device may drive a nonsensical white noise signal, or a decoy signal with the actual signal stegonagraphically encoded within. Thus, a user listening to the speakers through the analog output will hear only white noise or a decoy audio stream. Conversely, and end-user who has plugged in smart headphones may be able to listen to a decrypted audio stream with the actual audio output.

Thus, even if a malicious user is able to install a screen scraper, probe the audio output, or otherwise intercept the analog output, that malicious user will receive only the scrambled content. In the case of a deliberate counter-industrial-espionage operation, the malicious user may be provided with false data that appear to be legitimate, which not only protects the legitimate data, but also may help the enterprise to track the espionage by observing who seems to receive the false data.

It should also be recognized that not all of the display or the output needs to be scrambled. In some examples, it is desirable to provide a partly unscrambled display, but to scramble highly relevant or highly sensitive portions. Thus, in one example, a user connected to an enterprise VNC may have most applications on his display unencrypted, and designated as unimportant. On the other hand, while accessing enterprise applications, the windows of those specific applications may be scrambled.

This example may also bear on where encryption takes place. In the case of a full-screen encryption, encryption may take place on the device itself in hardware. Depending on the application, it can be advantageous to eliminate the need for software drivers. Thus, with full-screen encryption, the entire display can be driven by hardware with only low level software. Conversely, with application level scrambling, operating system hooks may be inserted to identify which application windows are to be scrambled, and to ensure that they are scrambled. In yet another example, an entire application need not be scrambled, but rather individual fields may be scrambled. For example, if the user is working on input forms where a plurality of data fields are provided, it may be desirable to scramble highly sensitive data fields, such as Social Security numbers or other personally identifying information, while making other fields viewable by outside users.

These examples extend the applicability beyond data leakage or industrial espionage to enabling useful limitations within an enterprise. For example, in the case of statistical or drug studies, it may be desirable to conceal certain data fields from certain actors, such as in “double blind” studies. However, those data may still be visible to others using an interpreter and observing or overseeing the study.

The system may also be used in the context of government contracting, for example in a briefing where some participants have a certain security clearance, while other participants lack that security clearance. In that case, participants with the appropriate security clearance can receive an interpreter that permits them to view certain portions of a presentation that are classified, while the unclassified participants see only gibberish. Further granularity can be provided, so that multiple levels of classification can be handled, with each user seeing only those fields permitted by his or her security classification.

Another application of the present specification is in digital rights management (DRM). DRM is a trade-off between convenience on the one hand and protection on the other hand. In many cases, these goals are in direct contradiction. That which is more secure is less convenient, while that which is more convenient is less secure. Thus end users may not be willing to purchase content that is cumbersome to operate.

However, in some cases, it is worthwhile to protect content via strict DRM procedures. To provide just one example, movie studios often send out “screeners” to critics who watch a movie in advance of the public, and post reviews of the film before its release. However, it can be dangerous to send out screeners because reviewers have, in the past, ripped videos ahead of their theatrical release and distributed them via peer to peer filesharing, which may impact ticket sales.

In contrast, if critics are provided with scrambled screeners, and are required to operate an interpreter with a one-time use key, then the studios face a steeply reduced risk for data loss. Not only is it difficult for the reviewer to defeat the encryption, but this method effectively plugs the “analog hole” in those cases. The reviewer cannot even use a screen recorder to record the restricted content.

Indeed, the teachings of the present specification can be used to defeat any instance of a user exploiting the “analog hole” to defeat a DRM mechanism.

In the case of movie theaters, a scrambled display may be used to defeat the practice of recording a film via handheld digital video recorders. In that context, the use of smart glasses may be practical because theater audiences have shown a willingness to use 3-D glasses for an enhanced experience. Thus, in this case, an enhanced viewing experience, including for example 3-D video, may be provided via the interpreters. In the meantime, looking at the screen without interpreters would yield only a gibberish display, or alternately a lower quality display.

It should be recognized that the teachings of the present specification can be adapted to various security models.

In one example, the interpreter is provisioned ahead of time with a decryption key that will be used to descramble content. In this case, the interpreter need not be connected in real-time to a key server. Rather, key provisioning is performed in advance, with a key that may optionally expire after a time, but that is otherwise valid continuously. Thus, a corporate user may be provided with smart glasses that have been provisioned with a decryption key, and may then carry the smart glasses on travel and be able to access enterprise data, even on a train or airplane where he may not have reliable Internet access.

In another example, a one time key may be provisioned on-the-fly for each instance of viewing. This may be the case, for example, in the instance of a movie screener. When the critic receives the screener and wishes to watch it, he connects to a key server with smart glasses, and the key server provides a decryption key that is valid for one-time use. The critic then watches the video, and then once the video ends, the key expires. In this case, the screener disc may not even play unless it can also contact the key server for a one time key. Thus, the danger of the user hacking his smart glasses to remove the expiration can also be alleviated.

It should also be recognized that interaction between the interpreter and the display may vary. In one example, the interpreter is tightly coupled to the display, and the display explicitly informs the interpreter of which portions of the output to descramble. For example, the display may identify a range of pixels that are to be decrypted, and the interpreter may descramble those specific pixels.

In another example, the display and the interpreter are not tightly coupled. In fact, they may operate completely independently, with the exception that they share a common key pair for decryption. In that case, the output itself may include markers that identify an encrypted portion. For example, with a rectangular window, the corners of the window may be marked with a special digital watermark or token that identifies the edges of the scrambled portion. Smart glasses may identify the watermark or tokens, and restrict the descrambling to portions within the watermark. Similarly, in the case of audio scrambling, the display device may explicitly inform the interpreter of which portions of the audio outputs are encrypted, via an audio watermark. Alternately, there may be embedded in the scrambled audio stream certain tokens that inform the interpreter of which portions to descramble. In some cases, the output may even include, for example, one half (i.e., a public key) of a symmetric key pair. Thus, the interpreter can operate completely independently of explicit communication with the display as long as the interpreter holds the other half of the symmetric key pair.

Embedding can be particularly useful in the case where a decoy output stream is used. Because there is no explicit control plane, a malicious actor trying to snoop on the stream may not be able to deduce the presence of the encrypted stream. However, the interpreter, being provisioned with the necessary tokens to understand the steganographically encoded data within the stream, may be able to identify and decrypt the scrambled portion of the stream.

A system and method according to the present specification will now be described with more particular reference to the appended FIGURES. Throughout the FIGURES, common numerals are used to specify common elements across multiple FIGURES. However, this is not intended to imply a necessary or strict relationship between different embodiments disclosed herein. In some cases, one or more different examples or species of the same elements may be referred to in a hyphenated form. Thus, for example, the numerals 10-1 and 10-2 may refer to two different species or examples of a class of objects referred to as 10.

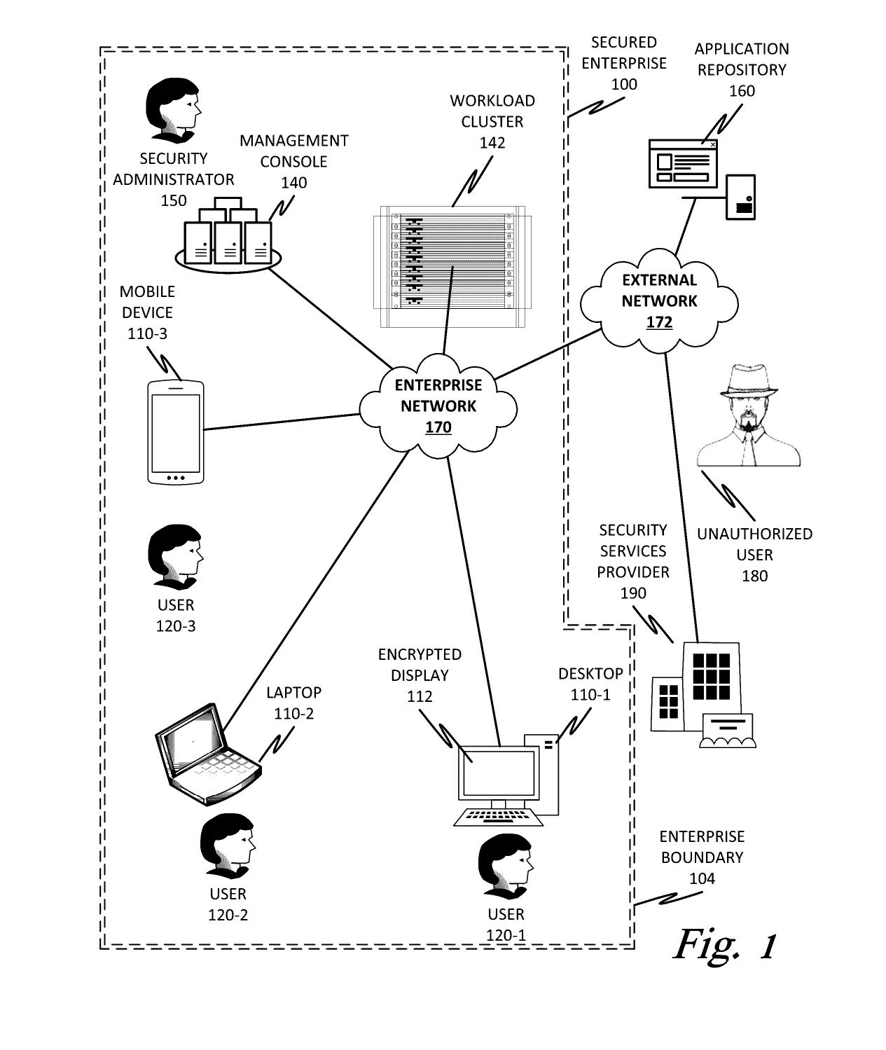

FIG. 1 is a network-level diagram of a secured enterprise 100 according to one or more examples of the present specification. In the example of FIG. 1, a plurality of users 120 operate a plurality of client devices 110. Specifically, user 120-1 operates desktop computer 110-1. User 120-2 operates laptop computer 110-2. And user 120-3 operates mobile device 110-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 110-1, which in one embodiment may be an engineering workstation, may be more likely to use one of Microsoft Windows, Linux, Unix, or Mac OSX. Laptop computer 110-2, which is usually a portable off-the-shelf device with fewer customization options, may be more likely to run Microsoft Windows or Mac OSX. Mobile device 110-3 may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within workload cluster 142. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

A workload cluster 142 may be provided, for example as a virtual cluster running in a hypervisor on a plurality of rack-mounted blade servers, or as a cluster of physical servers. Workload cluster 142 may provide one or more server functions, or one or more “microclouds” in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors, including agentful and agentless VMs. It should also be noted that some functionality of endpoint devices 110 may also be provided via workload cluster 142. For example, one microcloud may provide a remote desktop hypervisor such as a Citrix workspace, which allows users 120 operating endpoints 110 to remotely login to a remote enterprise desktop and access enterprise applications, workspaces, and data. In that case, endpoint 110 could be a “thin client” such as a Google Chromebook, running only a stripped-down operating system, and still provide user 110 useful access to enterprise resources.

One or more computing devices configured as a management console 140 may also operate on enterprise network 170. Management console 140 may provide a user interface for a security administrator 150 to define enterprise security policies, which management console 140 may enforce on enterprise network 170 and across client devices 110 and workload cluster 142. In an example, management console 140 may run a server-class operating system, such as Linux, Unix, or Windows Server. In other case, management console 140 may be provided as a web interface, on a desktop-class machine, or via a VM provisioned within workload cluster 142.

Secured enterprise 100 may encounter a variety of “security objects” on the network. A security object may be any object that operates on or interacts with enterprise network 170 and that has actual or potential security implications. In one example, security objects may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Enterprise security policies may include authentication policies, network usage policies, network resource quotas, antivirus policies, and restrictions on executable objects on client devices 110 by way of non-limiting example.

Secure enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an unauthorized user 180 (or other similar malicious or negligent actor) also connects to external network 172. A security services providers 190 may provide services to secured enterprise 100.

It may be a goal of users 120 and secure enterprise 100 to successfully operate client devices 110 and workload cluster 142 without interference from unauthorized user 180 or from unwanted security objects. In one example, unauthorized user 180 is a malware author whose goal or purpose is to cause malicious harm or mischief. The malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of unauthorized user 180 may be to install his malware on one or more client devices 110. As used throughout this specification, malicious software (“malware”) includes any security object configured to provide unwanted results or do unwanted work. In many cases, malware objects will be executable objects, including by way of non-limiting examples, viruses, trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Unauthorized user 180 may also want to commit industrial or other espionage against secured enterprise 100, such as stealing classified or proprietary data, stealing identities, or gaining unauthorized access to enterprise resources. Thus, unauthorized user 180's strategy may also include trying to gain physical access to one or more client devices 110 and operating them without authorization, so that an effective security policy may also include provisions for preventing such access.

Thus, a further goal of enterprise 100 may be to operate enterprise resources without unauthorized user 180 viewing them. In this context, unauthorized user 180 may not be a malicious external actor, but rather merely an individual with enterprise 100 that lacks the necessary authorization to view content on a particular client device 110.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious himself, a developer contributing software to application repository 160 may inadvertently provide attack vectors for unauthorized user 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Application repository 160 may represent a Windows or Apple “app store” or update service, a Unix-like repository or ports collection, or other network service providing users 120 the ability to interactively or automatically download and install applications on client devices 110. If application repository 160 has security measures in place that make it difficult for unauthorized user 180 to distribute overtly malicious software, unauthorized user 180 may instead stealthily insert vulnerabilities into apparently-beneficial applications.

In some cases, secured enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 120.

Secured enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, secured enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

Collectively, any object that is or can be designated as belonging to any of the foregoing classes of undesirable objects may be classified as a malicious object. When an unknown object is encountered within secured enterprise 100, it may be initially classified as a “candidate malicious object.” This designation may be to ensure that it is not granted full network privileges until the object is further analyzed. Thus, it is a goal of users 120 and security administrator 150 to configure and operate client devices 110, workload cluster 142, and enterprise network 170 so as to exclude all malicious objects, and to promptly and accurately classify candidate malicious objects.

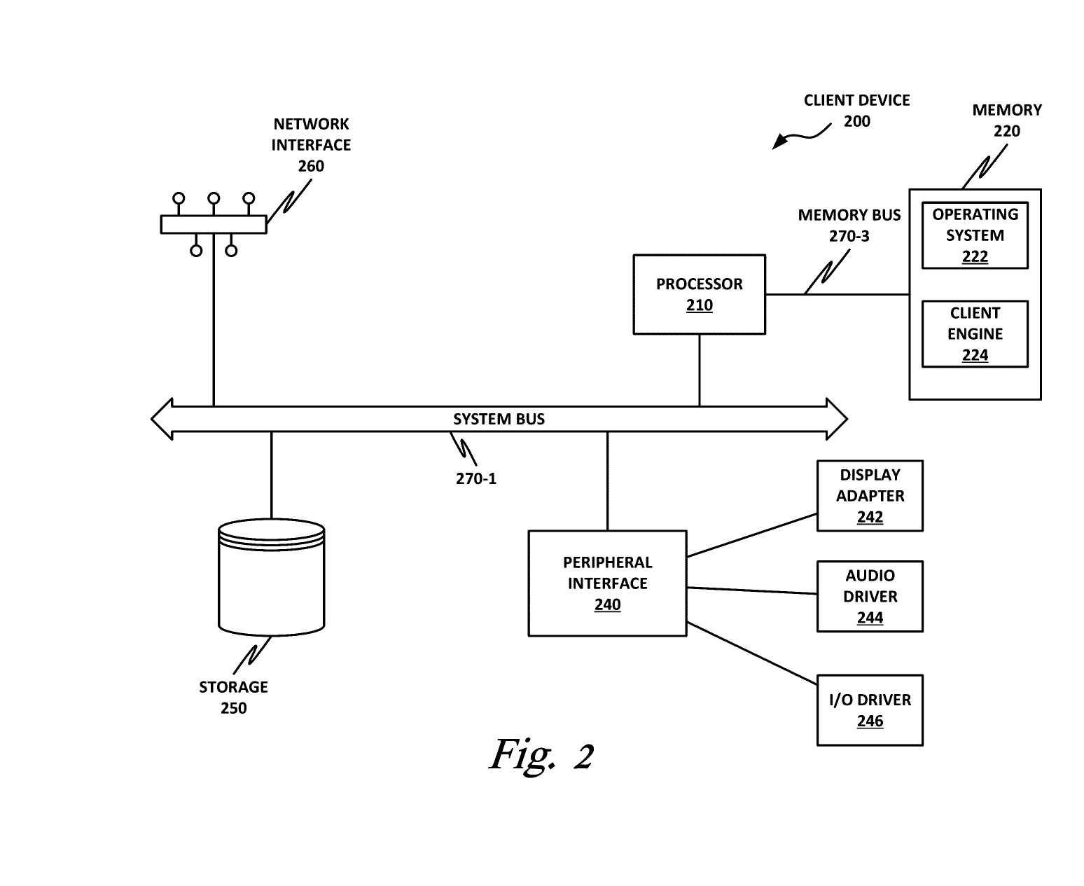

FIG. 2 is a block diagram of client device 200 according to one or more examples of the present specification. Computing device 200 may be any suitable computing device. In various embodiments, a “computing device” may be or comprise, by way of non-limiting example, a computer, workstation, server, mainframe, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

In certain embodiments, client devices 110 may all be examples of computing devices 200.

Computing device 200 includes a processor 210 connected to a memory 220, having stored therein executable instructions for providing an operating system 222 and at least software portions of a security engine 224. Other components of client device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of security engine 224. Many other configurations are also possible, and are intended to be encompassed within the broad scope of this specification.

Network interface 260 may be provided to communicatively couple client device 200 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Security engine 224, in one example, is operable to carry out computer-implemented methods as described in this specification. Security engine 224 may include one or more tangible non-transitory computer-readable mediums having stored thereon executable instructions operable to instruct a processor to provide a security engine 224. As used throughout this specification, an “engine” includes any combination of one or more logic elements, of similar or dissimilar species, operable for and configured to perform one or more methods provided by the engine. Thus, security engine 224 may comprise one or more logic elements configured to provide methods as disclosed in this specification. In some cases, security engine 224 may include a special integrated circuit designed to carry out a method or a part thereof, and may also include software instructions operable to instruct a processor to perform the method. In some cases, security engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that security engine 224 may also include other hardware and software, including configuration files, registry entries, and interactive or user-mode software by way of non-limiting example.

In one example, security engine 224 includes executable instructions stored on a non-transitory medium operable to perform a method according to this specification. At an appropriate time, such as upon booting client device 200 or upon a command from operating system 222 or a user 120, processor 210 may retrieve a copy of the instructions from storage 250 and load it into memory 220. Processor 210 may then iteratively execute the instructions of security engine 224 to provide the desired method.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

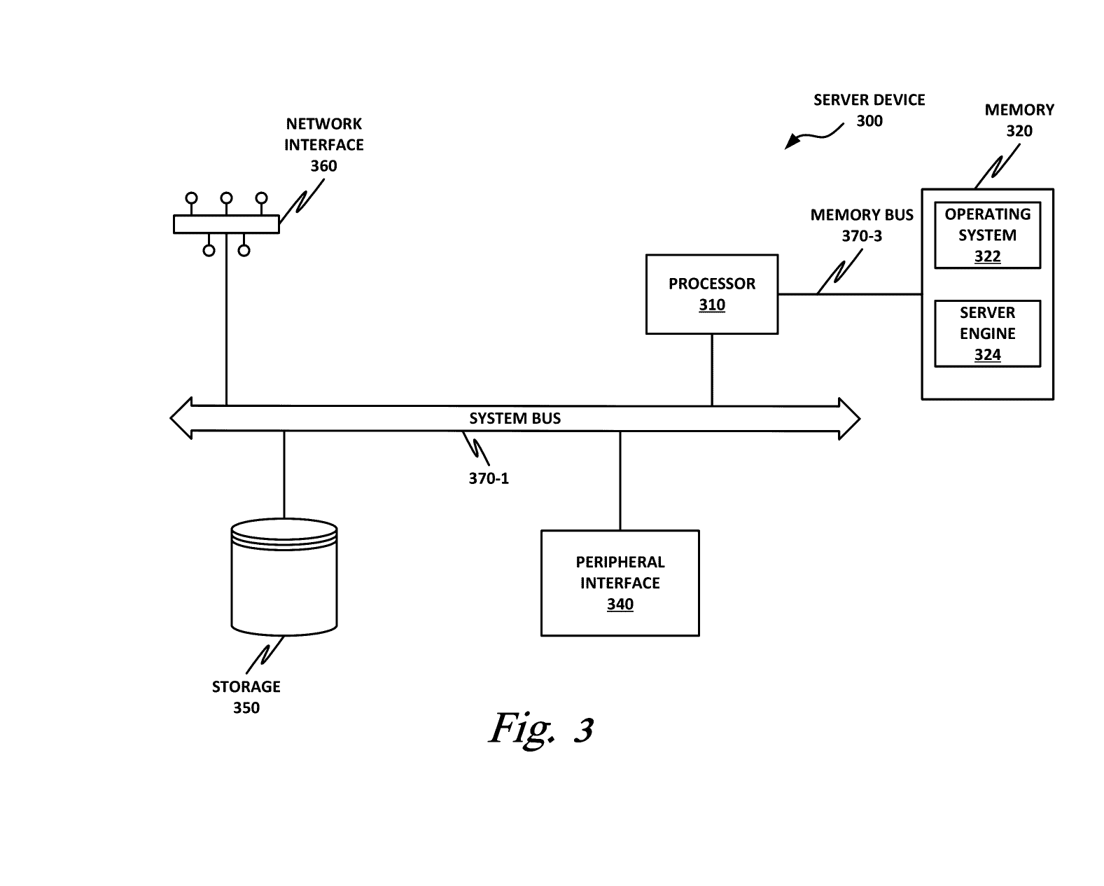

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations according to this specification may be divided along a client-server model, wherein client device 200 provides certain localized tasks, while server 300 provides certain other centralized tasks. In contemporary practice, server 300 is more likely than client device 200 to be provided as a “headless” VM running on a computing cluster, or as a standalone appliance, though these configurations are not required.

Server 300 includes a processor 310 connected to a memory 320, having stored therein executable instructions for providing an operating system 322 and at least software portions of a server engine 324. Other components of server 300 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of server engine 324.

Network interface 360 may be provided to communicatively couple server 140 to a wired or wireless network, and may include one or more logic elements as described in FIG. 2.

Server engine 324 is an engine as described in FIG. 2 and, in one example, includes one or more logic elements operable to carry out computer-implemented methods as described in this specification. Software portions of server engine 324 may run as a daemon process.

Server engine 324 may include one or more non-transitory computer-readable mediums having stored thereon executable instructions operable to instruct a processor to provide a security engine. At an appropriate time, such as upon booting server 140 or upon a command from operating system 322 or a user 120 or security administrator 150, processor 310 may retrieve a copy of server engine 324 (or software portions thereof) from storage 350 and load it into memory 320. Processor 310 may then iteratively execute the instructions of server engine 324 to provide the desired method.

Peripheral interface 340 may be configured to interface with any auxiliary device that connects to server 300 but that is not necessarily a part of the core architecture of server 300. Peripherals may include, by way of non-limiting examples, any of the peripherals disclosed in FIG. 2. In some cases, server 300 may include fewer peripherals than client device 200, reflecting that it may be more focused on providing processing services rather than interfacing directly with users.

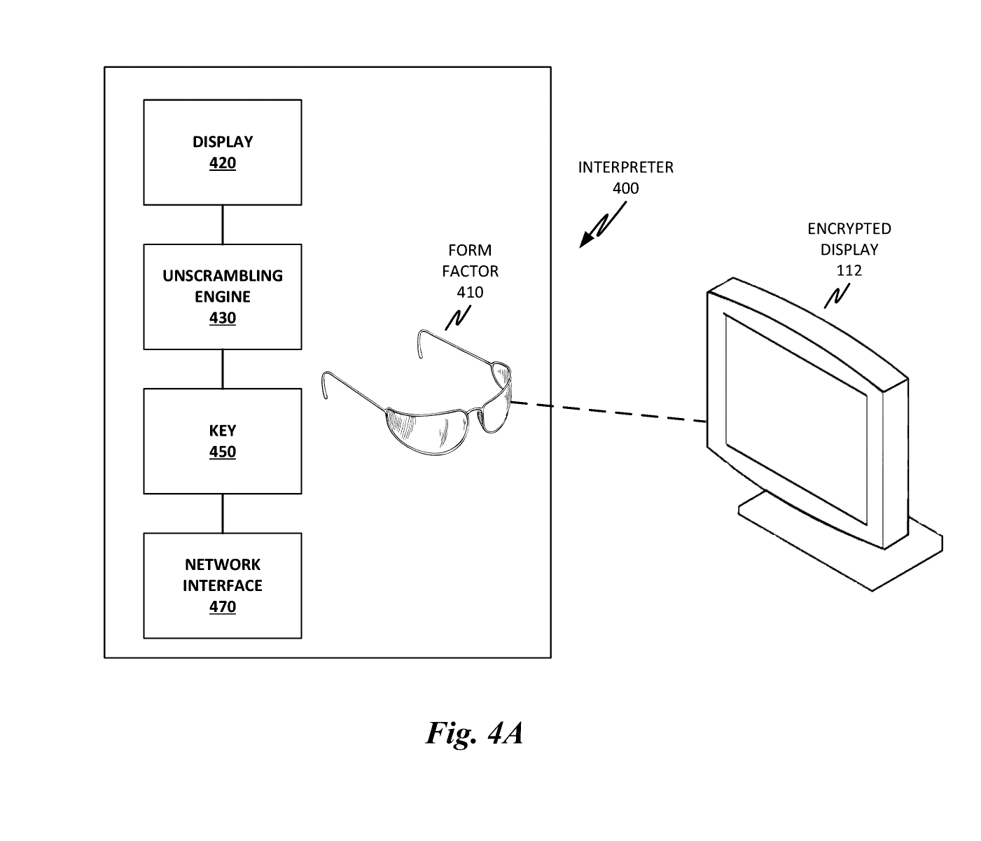

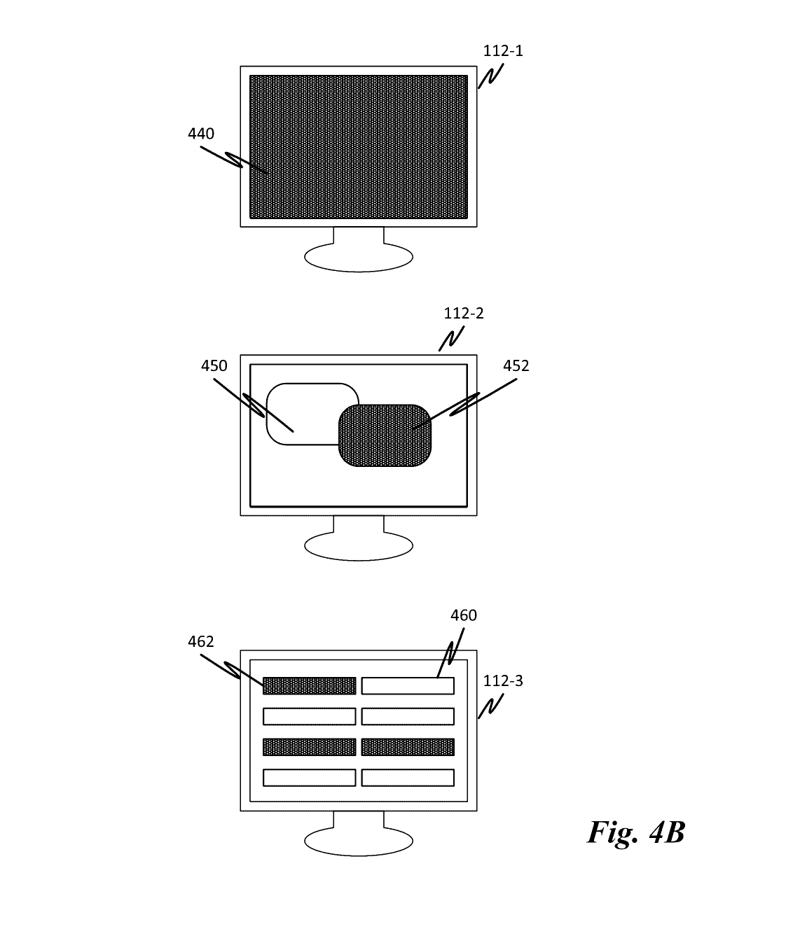

FIG. 4A is a block diagram of an interpreter 400 interacting with an encrypted display 112 according to one or more examples of the present specification. It should be noted that in this example encrypted display 112 is disclosed as a visual display, but this is a nonlimiting example only. Any suitable type of output device could be used. For example, encrypted display 112 could be an audio output, a printer, 3-D printer, tactile output, or any other suitable form of output. In a general sense, encrypted display 112 may provide any perceptible output, operable to drive a response on any sense or combination of senses (sight, sound, touch, taste, smell, balance, acceleration, temperature, kinesthetic sense, nociception, or any internal sense). It should also be noted that not all available senses are human senses. Various animals have non-human senses, such as echolocation and magnetoception. An encrypted display 112 may be configured or adapted to drive any of these senses as well in appropriate circumstances. For example, in an animal training device, the scrambled portion of the display may be an output that only the animal being trained can detect, while the unscrambled version may be a human-perceptible analog, allowing a human trainer to “see” or “hear” for example various tones of a dog whistle. Thus, any signal perceptible by a living organism may be referred to herein as an “organically perceptible” signal. An organically perceptible signal may be map to (i.e., be an analog of) a digital or scrambled signal that is machine reproducible but not organically perceptible.

Similarly, interpreter 400 is disclosed by way of illustration as smart glasses. However, interpreter 400 could similarly be a smart phone with a camera for capturing images and decoding the images to a display of the smart phone, smart speakers, smart headphones or earbuds, or any other device operable to translate a scrambled output from encrypted display 112 to an unscrambled output for an end-user.

By way of example, interpreter 400 has a form factor 410. Form factor 410 may be a form factor selected to be both functional, such as eyeglasses form factor, and also may accommodate the processing and logic necessary for performing the functions of interpreter 400.

In this example, interpreter 400 includes a multilayer stack for performing its interpreting function. This includes, by way of nonlimiting example, a network interface 470, a decryption key 450, an unscrambling engine 430, and a display 420.

In this example, network interface 470 may be adapted to communicate with encrypted display 112 or with a server device 142. This may allow interpreter 400 to receive explicit signals from encrypted display 112, a decryption key 450 from server 142, or other suitable data.

Interpreter 400 thus receives decryption key 450, which it may use to decrypt data from encrypted display 112. Encryption key 450 may be a pre-provisioned permanent key, a key with an expiry, a one-time key, or a key provided interactively in real-time with server 142.

Unscrambling engine 430 is an engine as described herein. Unscrambling engine 430 enables interpreter 400 to identify scrambled portions of the output from encrypted display 112, descramble the portions, and translate that descrambled data into a form suitable for driving an organically perceptible analog output.

Display 420 may be a visible display, such as a display shown on the lenses of smart glasses, or any other suitable output as discussed herein.

FIG. 4B illustrates additional details of encrypted display 112. Specifically, in example 112-1, a fully encrypted display 440 is disclosed. In this case, a user looking at the screen would see only gibberish, and no information would be visible.

In the example of encrypted display 112-2, only selected applications are encrypted. In this case, application 450 is unencrypted and is clearly visible to external users.

Conversely, application 452 is fully encrypted, and users viewing this particular application may see only gibberish, or a decoy display.

In the example of encrypted display 112-3, a form is shown with a plurality of fields. Fields 460 are unencrypted and plainly visible, while field 462 is encrypted. It should be noted that any of displays 112-1, 112-2, 112-3, or any other arrangements may be provided with either a fully scrambled output that will appear to be gibberish to an external user, or with a decoy output that will display a false image. For example, in one embodiment, with a fully encrypted display 112-1, the output could appear to an external user to be a movie playing. However, there may be inserted into the movie an occasional frame with encrypted data. In another example, display 112-1 displays a graphic image that appears to be an ordinary desktop, for example with an email program open or some other benign data. However, embedded within that display is a steganographic token that provides encrypted data for driving a totally different display.

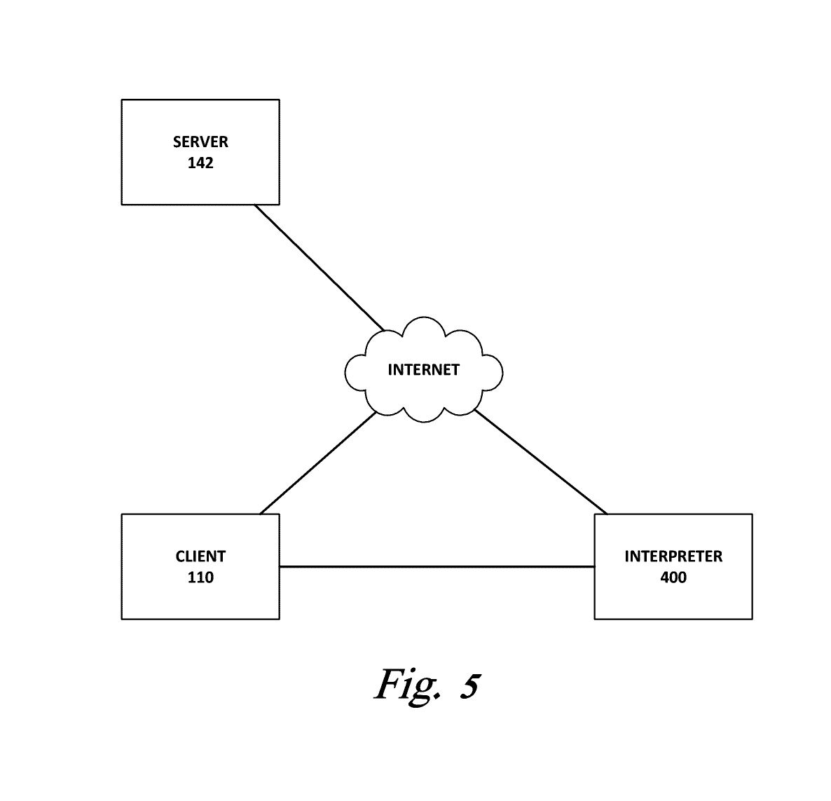

FIG. 5 is a high-level block diagram illustrating that interpreter 400, client device 110 with a scrambled display, and key server 142 may be individually connected, for example via the Internet 172, or some other suitable network. In other examples, interpreter 400 may have a direct local connection to client 110. Many other interconnection arrangements are possible.

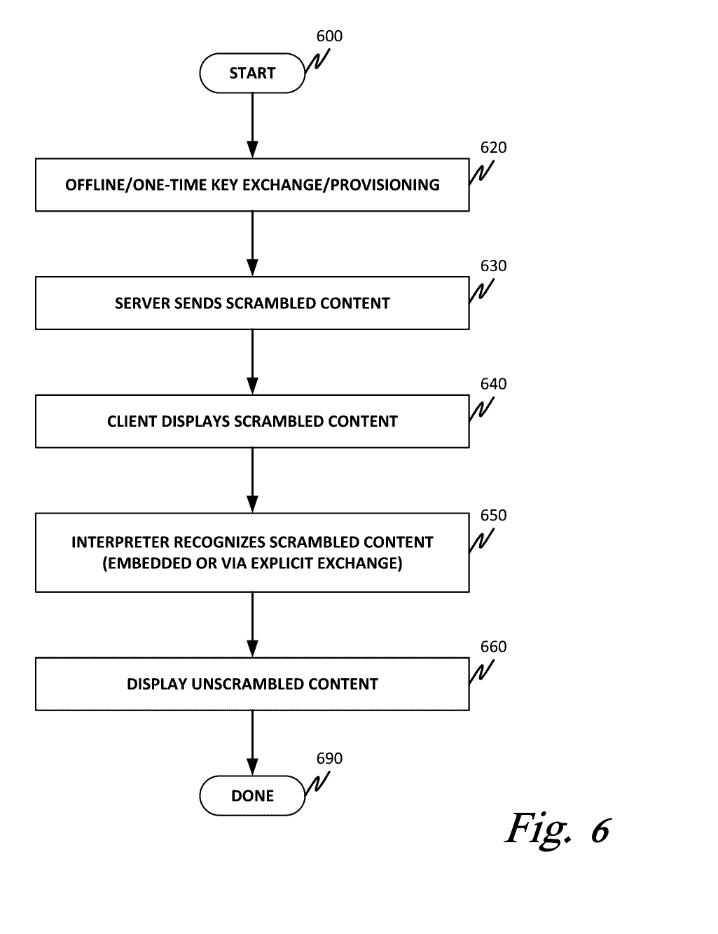

FIG. 6 is a flowchart of a method 600 according to one or more examples of the present specification.

In block 620, and off-line one time key exchanger (provisioning) takes place. This is referred to as a one-time key exchange by way of example only, and it should be understood that the key may have an expiry, in which case the “one-time” key exchange may need to take place after each key expires. In this case, the key may be provided via out-of-band means, such as physically providing a copy of the key to the user on a USB thumb drive, a printout, or by some other means. Alternately, key provisioning may take place over the Internet, although this is often considered less secure. Regardless of how the keys are exchanged, server 142 (or client device 110 itself) provides a decryption key or analogous unscrambling token to interpreter 400.

In block 630, server 142 may send scrambled content to client device 110. This envisions an architecture in which the server itself is providing the content. It should be noted however that this is provided by way of nonlimiting example only. In other examples, content may be generated and scrambled locally on client device 110.

In block 640, client device 110 displays the scrambled content. It should be understood that displaying the scrambled content includes any form of output that is provided in a scrambled or encrypted format. The output itself may be organically perceptible in the sense that a target audience (e.g., a human user) can perceive that something is displayed. However, the meaning of the display is concealed, either as gibberish or via a decoy.

In block 650, interpreter 400 recognizes the scrambled content. This may occur either via an explicit exchange between the client device 120 and interpreter 400, or via a recognition algorithm, or via anchors embedded in the scrambled content itself.

In block 660, interpreter 400 descrambles the display, and provides the display to the user in a human readable fashion.

In block 690, the method is done.

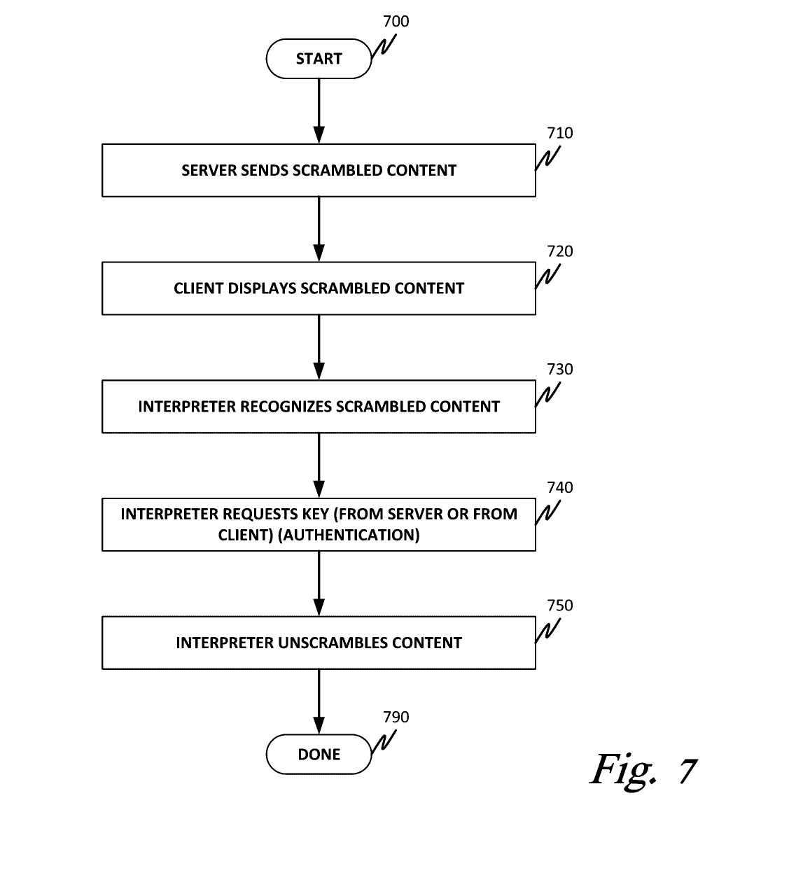

FIG. 7 is a flow chart of an alternative method 700 performed according to one or more examples of the present specification.

In this example, in block 710, server 142 sends scrambled content to client device 110. Alternately, client device 110 may generate and scramble the content locally.

In block 720, client device 110 displays the scrambled content.

In block 730, interpreter 400 recognizes the scrambled content. Again it should be noted that this may be according to any of the recognition methods disclosed herein.

In block 740, interpreter 400 requests a decryption key, either from server 142 or directly from client 110. This may include an authentication operation, wherein interpreter 400 authenticates itself to server 142 or client device 110. After properly authenticating interpreter 400, server 142 or client device 110 provides the appropriate key to interpreter 400.

In block 750, interpreter 400 descrambles the content and displays it to the user according to any of the methods disclosed herein.

In block 790, the method is done.

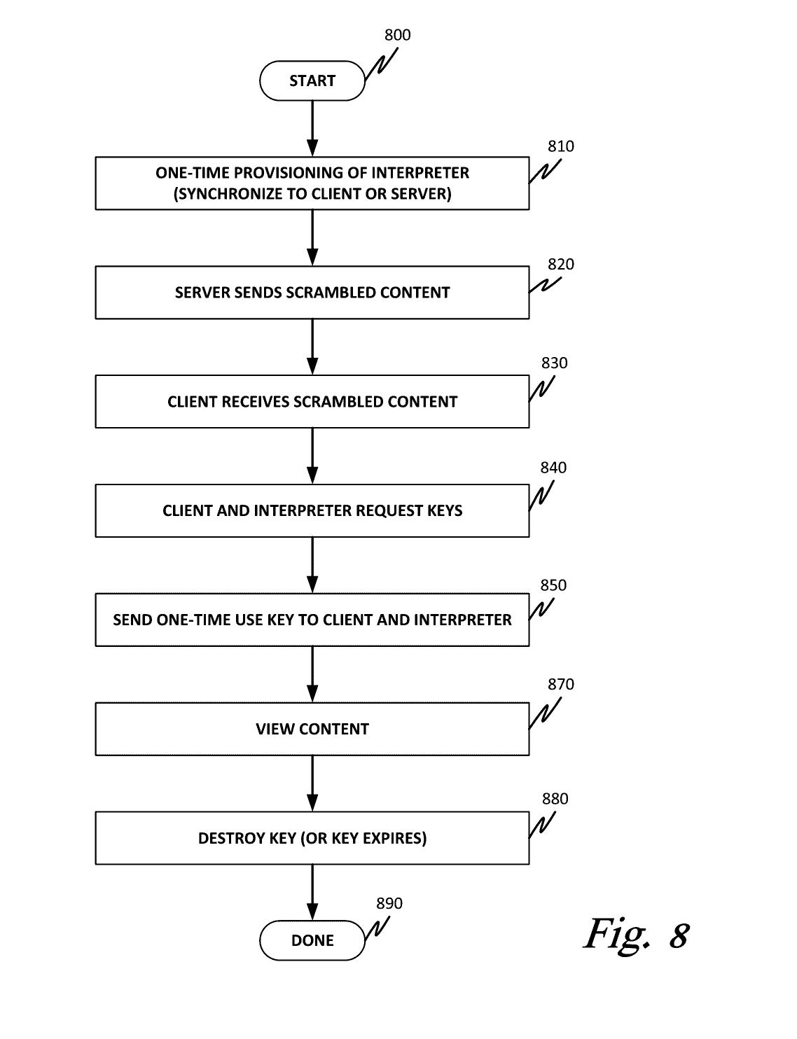

FIG. 8 is a flowchart of a method 800 according to one or more examples of the present specification.

In this example, there may be optionally a one-time provisioning of interpreter 400, in which it is synchronized with client device 110 or with server 142.

In block 820, server 142 sends the scrambled content to client device 110. Alternatively, client device 110 may locally generate and scramble the content.

In block 830, client device 110 receives the scrambled content.

In block 840, client 110 and interpreter 400 both request a key from server 142.

In block 850, server 142 sends a one-time key to both client 110 and interpreter 400.

In block 870, a user 120 views the content via interpreter 400.

In block 880, the one-time key expires, or the respective devices destroy it. In either case, the key is no longer valid, and cannot be used again. This may be useful, for example, for a strict case of DRM, where it is desirable to strictly enforce one-time use only.

In block 890, the method is done.

In one example application, a two device scrambled display may be used in a production environment, such as a “fab.” A fab may have display of algorithms and system configurations that are not allowed to leave the fab. These may be made available to employees and contractors only under strict DRM control. A two device scrambled display may be used to display such protected data.

It should also be noted that a two device scrambled display may provide DRM integration, as well as audit logging and usage controls for even tighter security over important data. Logging may include user access, date, time, duration per document, and controlled data boundaries.

In another application, a two device scrambled display is provided for use with shared documents, such as “cloud” based document editing. Certain portions of the shared document may be scrambled and available only to users with a proper interpreter.

In another application, a physical token such as an authentication bracelet, dongle, or RFID badge is required before the interpreter will operate. Other security safeguards may include two-factor authentication, biometric authentication (including retinal scans), and similar. In one example, the interpreter includes smart glasses that scan the user's retinal pattern in real-time to ensure that the user is still watching. This helps prevent potential compromises by using a recording device to capture the output of the interpreter.

In another application, stereoscopic support may be provided, relying on human interpretation of two images to complete a single perceptible image. This may be another failsafe against recording devices simply recording the output of the interpreter.

It should be noted that digital encryption is used throughout this specification as one example of an effective scrambling method, and that “scrambling” as used throughout this specification is intended to cover any suitable method of reversible scrambling, such as analog scrambling (additive or multiplicative, for example), frequency hopping, or similar. Thus, it should be understood that where digital key-based encryption is spoken of specifically, this is a nonlimiting example only. Analog scrambling engines provide, for example, a “sync word” or sync tone that may be treated as the equivalent of an encryption key when used with an appropriate pseudo-random bit sequence (PRBS), which may be provided by a linear feedback shift register (LFSR). In that case, a demodulator may be used in place of a decryption engine.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise reflected in the appended claims.

### EXAMPLE IMPLEMENTATIONS

In an example, there is disclosed an interpreter apparatus, comprising: an input driver for receiving a scrambled input; an output driver for displaying an organically perceptible (including human-perceptible) output; and one or more logic elements comprising a unscrambling engine operable for: receiving an input on the input driver; detecting that at least a portion of the input is scrambled; unscrambling the scrambled portion of the input; and outputting an unscrambled analog of the scrambled input via the output driver.

There is further disclosed an example wherein the input driver is a video driver.

There is further disclosed an example wherein receiving the input comprises capturing a digitized image of the input.

There is further disclosed an example wherein the input driver is an audio driver.

There is further disclosed an example wherein recognizing that at least a portion of the input is scrambled comprises recognizing an embedded token in the scrambled portion.

There is further disclosed an example wherein recognizing that at least a portion of the input is scrambled comprises receiving an explicit identification of the scrambled portion.

There is further disclosed an example wherein the unscrambling engine is further operable for performing a one-time key provisioning with a key server.

There is further disclosed an example wherein unscrambling the scrambled portion comprises receiving a one-time key.

There is further disclosed an example wherein unscrambling the scrambled portion comprises receiving a key with a timed expiry.

There is further disclosed an example wherein unscrambling the scrambled portion comprises syncing with a key server or client device and receiving a decryption key.

There is further disclosed an example wherein unscrambling the scrambled portion comprises extracting data from a decoy display.

There is further disclosed an example wherein unscrambling the scrambled portion comprises extracting steganographically-encoded data from a decoy display.

There is further disclosed an example wherein the unscrambling engine is operable for performing a sync with a key server or a client device, and wherein unscrambling the scrambled portion comprises receiving a one-time decryption key.

There is further disclosed an example of a client apparatus, comprising: an output driver for a human-perceptible output; and one or more logic elements comprising a scrambling engine operable for: scrambling an output via an encryption key; and outputting the the scrambled output via the output driver.

There is further disclosed an example wherein outputting the scrambled output via the output driver comprises outputting a decoy output display.

There is further disclosed an example wherein outputting the scrambled output via the output driver comprises steganographically embedding a signal in the decoy display.

There is further disclosed an example wherein outputting the scrambled output via the output driver comprises driving an audio or video output.

There is further disclosed an example wherein outputting the scrambled output via the output driver comprises scrambling less than the full output.

There is further disclosed an example wherein outputting the scrambled output via the output driver comprises scrambling only one or more selected applications.

There is further disclosed an example wherein outputting the scrambled output via the output driver comprises scrambling only one or more selected fields.

There is further disclosed by way of example one or more non-transitory tangible computer-readable mediums having stored thereon executable instructions for instructing one or more processor for providing an encryption or unscrambling engine operable for performing some or all of the operations of any of the preceding examples.

There is further disclosed by way of example a method comprising performing some or all of the operations of the preceding examples.

There is further disclosed by way of example an apparatus comprising means for performing the method of any of the preceding examples.

There is further disclosed an example wherein the apparatus is a computing apparatus.

There is further disclosed an example wherein the means comprise a processor and a memory.

What is claimed is:

1. An interpreter apparatus, comprising:
an input driver for receiving a scrambled input;
an output driver for displaying an organically perceptible output; and
one or more logic elements comprising a unscrambling engine operable for:
receiving an input on the input driver;
detecting that at least a portion of the input is scrambled;
unscrambling the scrambled portion of the input; and
outputting an unscrambled analog of the scrambled input via the output driver.

2. The computing apparatus of claim 1, wherein the input driver is a video driver.

3. The computing apparatus of claim 2, wherein receiving the input comprises capturing a digitized image of the input.

4. The computing apparatus of claim 1, wherein the input driver is an audio driver.

5. The computing apparatus of claim 1, wherein recognizing that at least a portion of the input is scrambled comprises recognizing an embedded token in the scrambled portion.

6. The computing apparatus of claim 1, wherein recognizing that at least a portion of the input is scrambled comprises receiving an explicit identification of the scrambled portion.

7. The computing apparatus of claim 1, wherein the unscrambling engine is further operable for performing a one-time key provisioning with a key server.

8. The computing apparatus of claim 1, wherein unscrambling the scrambled portion comprises receiving a one-time key.

9. The computing apparatus of claim 1, wherein unscrambling the scrambled portion comprises receiving a key with a timed expiry.

10. The computing apparatus of claim 1, wherein unscrambling the scrambled portion comprises syncing with a key server or client device and receiving a decryption key.

11. The computing apparatus of claim 1, wherein unscrambling the scrambled portion comprises extracting data from a decoy display.

12. The computing apparatus of claim 1, wherein unscrambling the scrambled portion comprises extracting steganographically-encoded data from a decoy display.

13. The computing apparatus of claim 1, wherein the unscrambling engine is operable for performing a sync with a key server or a client device, and wherein unscrambling the scrambled portion comprises receiving a one-time decryption key.

14. One or more non-transitory computer-readable mediums having stored thereon instructions operable for instructing one or more processors for providing a unscrambling engine, operable for:
receiving an input on an input driver;
detecting that at least a portion of the input is scrambled;
unscrambling the scrambled portion of the input; and
outputting an organically perceptible unscrambled analog of the scrambled input via an output driver.

15. The one or more tangible, non-transitory computer-readable mediums of claim 14, wherein receiving the input comprises capturing a digitized image of the input via a video driver.

16. The one or more tangible, non-transitory computer-readable mediums of claim 14, wherein receiving the input comprises capturing an audio stream via an audio driver.

17. The one or more tangible, non-transitory computer-readable mediums of claim 14, wherein recognizing that at least a portion of the input is scrambled comprises recognizing an embedded token in the scrambled portion.

18. T The one or more tangible, non-transitory computer-readable mediums of claim 14, wherein recognizing that at least a portion of the input is scrambled comprises receiving an explicit identification of the scrambled portion.

19. The one or more tangible, non-transitory computer-readable mediums of claim 14, wherein the unscrambling engine is further operable for performing a one-time key provisioning with a key server.

20. The one or more tangible, non-transitory computer-readable mediums of claim 14, wherein unscrambling the scrambled portion comprises receiving a one-time key.

21. The one or more tangible, non-transitory computer-readable mediums of claim 14, wherein unscrambling the scrambled portion comprises receiving a key with a timed expiry.

22. The one or more tangible, non-transitory computer-readable mediums of claim 14, wherein unscrambling the scrambled portion comprises syncing with a key server or client device and receiving a decryption key.

23. The one or more tangible, non-transitory computer-readable mediums of claim 14, wherein unscrambling the scrambled portion comprises extracting data from a decoy display.

24. A computing apparatus, comprising:
an output driver for a human-perceptible output; and
one or more logic elements comprising a scrambling engine operable for:
scrambling an output via an encryption key; and
outputting the scrambled output via the output driver.

25. The computing apparatus of claim 24, wherein outputting the scrambled output via the output driver comprises outputting a decoy output display.
